(19) United States
(12) Patent Application Publication
(10) Pub. No.: US 2016/0100562 A1
(43) Pub. Date: Apr. 14, 2016

(54) FISHING HOOK METHOD AND APPARATUS

(71) Applicant: John Souther, Benbrook, TX (US)

(72) Inventor: John Souther, Benbrook, TX (US)

(21) Appl. No.: 14/509,197

(22) Filed: Oct. 8, 2014

(51) Int. Cl. A01K 83/06

(52) U.S. Cl. CPC A01K 83/06

(57) ABSTRACT

A fish hook that is configured to have a secondary method of holding bait. The fish hook including an eye to accept fishing line. The hook having a body extending from the eye having a shank portion and a bend portion. A bait attachment member coupled to the hook body, wherein the bait attachment member includes a plurality of arms configured to move relative to one another in operation between an open and closed orientation. The bait attachment member configured to pivot and translate relative to the hook body to adjust to bait of different sizes. The bait attachment member being selectively contoured to engage and secure bait coupled to the hook body.

### BACKGROUND

1. Field of the Invention

The present application relates generally to fishing equipment and, more particularly, to a fishing-hook for improved holding of bait.

2. Description of Related Art

Various types of fishing-hooks are available in the market. Fishing-hooks typically include an eyelet and a body used for the purpose of holding bait and capturing fish. Soft bait used in catching some fish have difficulty in staying attached to conventional fishing-hooks. The tip of the fishing-hook is passed one or more times through the bait in order to prevent dislodging of the bait during casting, reeling, and in general, during normal fishing activities. However, soft bait typically moves and becomes separated from fishing-hooks.

It is desirable to provide an improved fishing-hook to secure soft bait during fishing. Although some advancements have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a fishing-hook according to the preferred embodiment of the present application;

FIG. 2 is an enlarged section view of an attachment member of the fishing-hook of FIG. 1;

FIG. 3 is a side view of an alternative embodiment of arms used in the attachment member of the fishing-hook of FIG. 2; and

FIG. 4 is an exemplary top view of an interlocking tip portion of the arms of FIG. 2.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The fishing-hook of the present application is configured to hold bait in a selected orientation relative to the fishing hook body. The fishing hook includes an eye and hook body having a shank portion and bend portion. A bait attachment member is coupled to the hook body. The bait attachment member includes two opposing arms to secure the bait in order to prevent loss during fishing. The arms are configured to pivot relative to one another to permit relative movement at opposing tip ends. The relative movement allows the opening and closing of the bait attachment member.

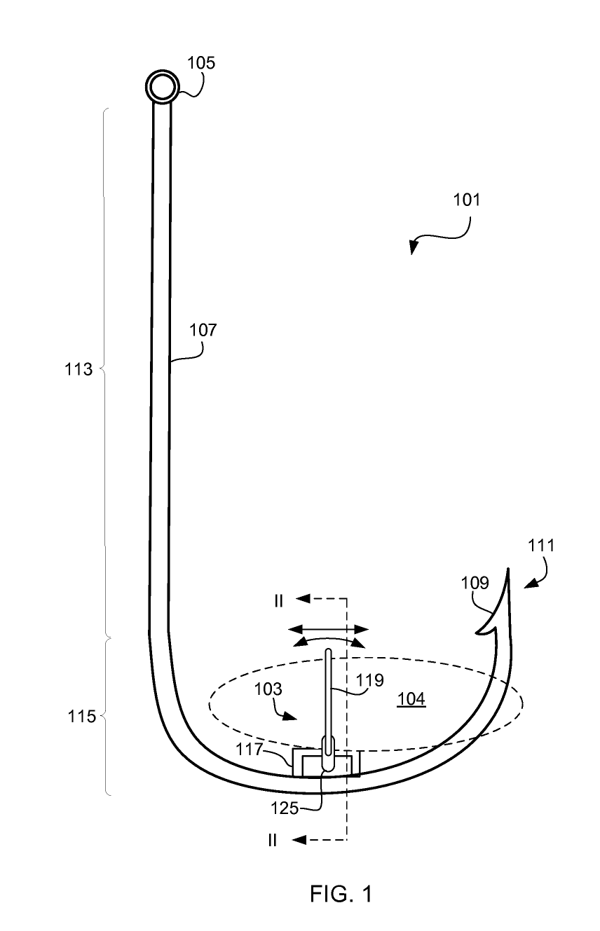

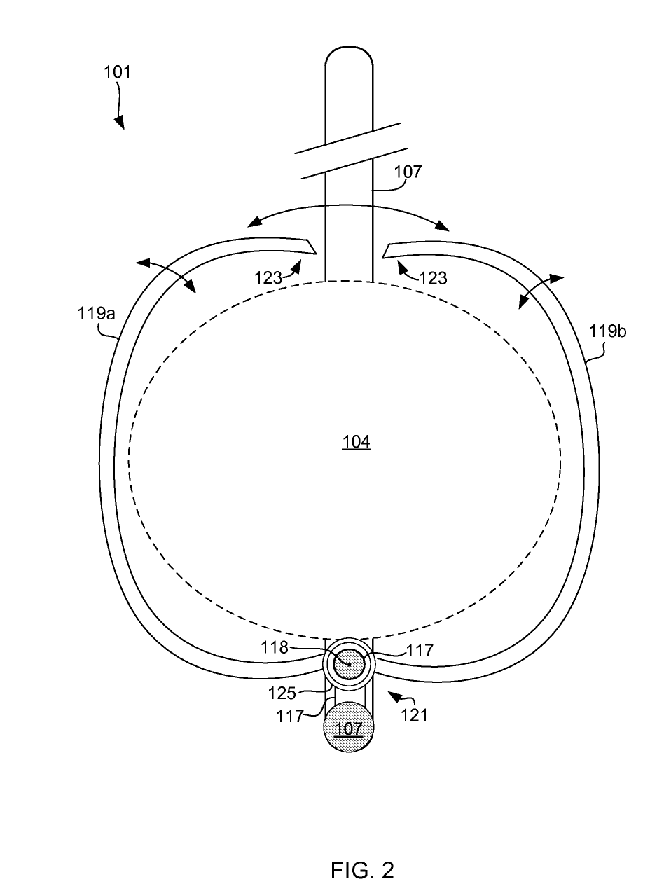

Referring now to FIGS. 1 and 2 in the drawings, a fishing-hook 101 is illustrated. Hook 101 is configured to provide a secondary attachment member used to secure bait 104 to the hook body. A first attachment member for holding bait 104 is the hook body 107 itself. Hook 101 includes a bait attachment member 103 configured to act as the secondary attachment member for securing bait 104. The term “bait” refers to any bait typically used by fisherman, including: live, dead, soft, and hard bait to name a few. Hook 101 also includes an eye 105, hook body 107, and an optional barb 109 at the tip 111 of hook 101.

Eyelet 105 is configured to receive a line and potentially one or more weights to permit the casting and retrieval of hook 101 into the water. Body 107 extends from eye 105 and is comprised of at least two portions: a shank portion 113 and a bend portion 115. Shank portion 113 extends from eye 105 and is linear or straight while bend portion 115 extends between tip 111 and shank portion 113. Bend portion 115 is curved and typically forms the bottom end of hook 101. As known in the art, the distance between tip 111 and shank portion 113 is called the gape. It is understood that hook 101 is not limited in size and shape to the precise drawing illustrated in FIG. 1. FIG. 1 is a representative illustration. The size and spacing of portion 113, portion 115, and the gape may be varied in different hooks to suit particular fishing situations. Hook 101 is not limited to any particular spacing or sizing. Hook 101, with the associated attachment member 103 may be used on hooks of various types: J-hooks, C-hooks, Z-hooks, treble hooks, and double hooks for example.

Bait attachment member 103 is coupled to hook body 107. In the preferred embodiment, member 103 is coupled directly within bend portion 115 of body 107. However, other embodiments may located member 103 in other locations on body 107 (i.e. shank portion 113). Where multiple hooks are used, hook 101 may include member 103 in one or more portions of each hook body.

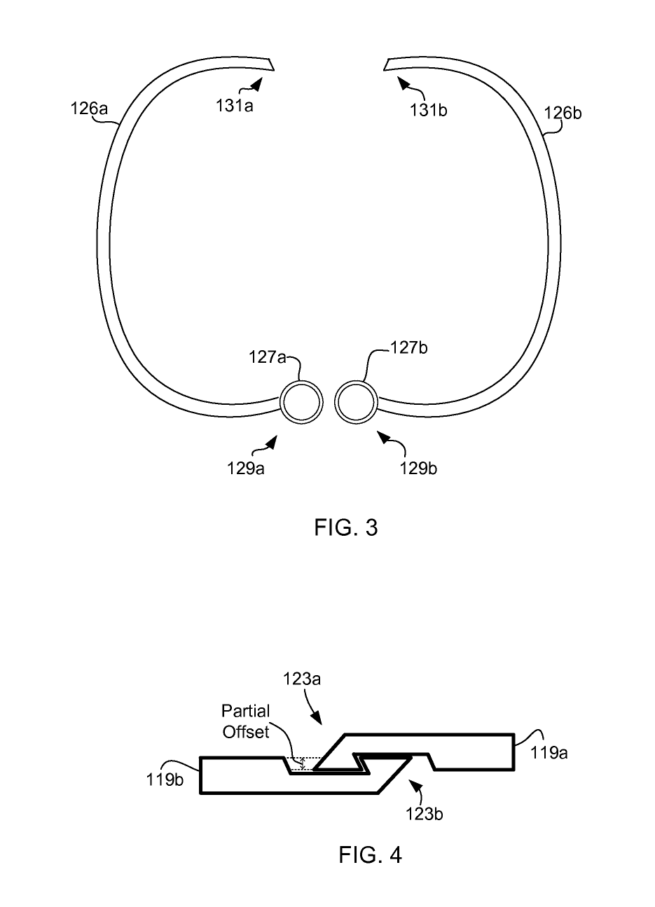

Member 103 is configured to swivel and/or pivot relative to body 107. A number of different embodiments may be used to permit this relative motion between member 103 and body 107. In FIGS. 1 and 2, hook 101 is illustrated wherein member 103 includes a loop 117 and a plurality of arms 119. Each of the plurality of arms are selectively contoured having a base end 121 and an opposing tip end 123 (see also FIG. 3), such that a first arm 119a is able to pivot relative to a second arm 119b about base end 121 so as to alternate between two orientations. The first orientation is where tip ends 123 of each arm 119 are connected (closed). In the second orientation, the tip ends 123 are separated relative to one another in an open configuration. Bait 104 is held between arms 119 when in a closed orientation and is selectively inserted or removed when arms 119 are in an open configuration. In order to ensure arms 119 remain closed, arms 119 may be configured to interlock (see FIG. 4).

As seen clearly in FIGS. 1 and 2, base end 121 is configured with a loop 125 to engage loop 117. Engagement of loops 117 and 125 permit arms 119 to move either parallel to and/or perpendicular to a plane formed from tip 111 to shank portion 113. Additionally, arms 119 are configured to translate along loop 117 to adjust to various sized baits. As bait 104 is placed between arms 119, arms 119 may either remain external to bait 104 or may be used to pierce through a portion of bait 104.

Although arms 119 have been disclosed having a selected contour, illustrated as being curved in nature, it is understood that arms 119 may consist of straight segments with bends between them. Additionally, arms 119 pivot about loop 117 around a common axis 118. It is understood other embodiments are considered wherein arms 119a and 119b move relative to one another about dissimilar axes of rotation.

Referring now also to FIG. 3 in the drawings, an alternative embodiment of arms 119 are illustrated. In FIG. 3, arms 126 are illustrated as each having a loop 127 at a base end 129. Arms 126a and 126b are similar in form and function to that of arms 119, except that each of arms 126 are configured as having a separate loop 127a, 127b as opposed to a singular loop 125 permitting mutual pivoting of arms 119. Arms 126 are configured as having tip ends 131a and 131b similar in form and function to that of tip ends 123.

Referring now also to FIG. 4 in the drawings, an exemplary top view of an exemplary interlocking tip portion for use with arms 119 and 126 is illustrated. Arms 119 and 126 are configured optionally to interlock to permit the selective release of bait 104. It is understood that the interlocking or relative retention of arms 119, 126 in the closed orientation may be performed in different ways. FIG. 4 is illustrative of an exemplary method but is not considered to be exhaustive. Latches, clips, hooks, snaps, and other attachment methods are conceivable. Each of arms 119 and 126 may include the type of interlocking shown and described within FIG. 4. For simplicity, arm 119 will be used in the discussion. Each of arms 119a and 119b are optionally configured to have opposing and engaging contours about tip ends 123. As seen, arms 119a and 119b are slightly offset from one another. There is only a partial offset thereby requiring an applied perpendicular force to be allied to ends 123 to permit a full offset and thereby the overlapping. Tip ends 123 are overlapped to permit the ends 123 to interlock or hook on to one another. Arms 119 are configured to remain closed until manually separated by the fisherman. The contour of ends 123 are made to hook one another. Additionally, because arms 119a and 119b only partially offset one another, in order to disengage the interlocking function, a perpendicular force also needs to be applied to fully offset ends 123 when opening arms 119. As noted previously, other methods and devices are considered possible to retain arms 119 in a closed position.

The current application has many advantages over the prior art including at least the following: (1) a secondary attachment member for bait; (2) bait attachment member that is able to translate within the gape of the hook; (3) selective open and close ability of arms; and (4) ability to pivot or rotate the bait attachment member relative to the hook body.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A fish hook for holding bait, comprising:
an eye configured to accept a fishing line;
a hook body extending from the eyelet, the hook body having a shank portion and a bend portion;
a bait attachment member coupled to the hook body, the bait attachment member including a plurality of arms, each of the plurality of arms being selectively contoured having a base end and an opposing tip end, the base end adjacent the hook body, the bait attachment member configured to engage and secure bait coupled to the hook body.

2. The fish hook of claim 1, wherein the bait attachment member is coupled to the bend portion of the hook body.

3. The fish hook of claim 1, wherein each of the plurality of arms includes an elongated body having a predetermined shape.

4. The fish hook of claim 3, wherein the elongated body is curved.

5. The fish hook of claim 3, wherein the elongated body is strait.

6. The fish hook of claim 1, wherein the plurality of arms are configured to pivot relative to each other.

7. The fish hook of claim 6, wherein the plurality of arms pivot about a common axis.

8. The fish hook of claim 6, wherein the plurality of arms move relative to one another about dissimilar axes.

9. The fish hook of claim 6, wherein the plurality of arms include a loop at the base end, the plurality of arms able to pivot so as to adjust the distance between the tip ends of the plurality of arms.

10. The fish hook of claim 6, wherein each of the plurality of arms include a loop at the base end, the loops creating matching concentric apertures about a common axis, the plurality of arms able to pivot so as to adjust the distance between the tip ends of the plurality of arms.

11. The fish hook of claim 1, wherein the distance between the tip ends of the plurality of arms are configured to be selectively adjusted to accommodate a variety of sized bait.

12. The fish hook of claim 11, wherein the tip ends of the plurality of arms are configured to interlock with one another to prevent undesired separation of the tip ends.

13. The fish hook of claim 1, wherein the bait attachment member is configured to swivel relative to the hook body.

14. The fish hook of claim 1, wherein the arms of the bait attachment member are configured to translate relative to the hook body.

15. The fish hook of claim 1, wherein the arms of the bait attachment member are configured to alternate between an open orientation and a closed orientation.
